(19) United States
(12) Patent Application Publication
(10) Pub. No.: US 2007/0053181 A1
(43) Pub. Date: Mar. 8, 2007

(54) Fireless and flameless biodegradable candle

(76) Inventor: Nishan Urkumyan, San Jose, CA (US)

Correspondence Address: NISHAN URKUMYAM, 2693 HOCKING WAY, SAN JOSE, CA, 95124, US

(21) Appl. No.: 11/210,448

(22) Filed: Aug. 25, 2005

(51) Int. Cl. F21V 35/00; H01R 13/46

(52) U.S. Cl. 362/161; 362/392; 362/569; 431/289; 439/123

(57) ABSTRACT

A disposable and biodegradable candle lamp made with candle wax, translucent wax, palm oil wax, soy bean wax or a vegetable oil wax, scented or unscented for decorative purposes where a low level of light intensity is desirable comprising a candle like body positioned on its bottom sealed surface. A light source of LED (Light Emitting Diode) powered with an embedded low power battery. A mold of fire flame used as a cap over the LED light source. A switch on the bottom surface controlling the function and on/off operation of the candle lamp.

This invention relates to portable, low power candle lamps and particularly to a battery operated biodegradable candle lamp made with palm oil wax, soy wax, bees wax and other vegetable oil wax. It is an object of this invention to provide a candle lamp that would be used in somewhat that same manner as the old fashion candle or lantern in that the candle lamp be locatable in most any area where a low level of light is required. It is another objective that the candle lamp is used in the areas where the real candle with a real flame is not allowed. This invention is a candle lamp comprising an LED (Light Emitting Diode) mounted on a candle made with a biodegradable palm oil wax, soy wax, beeswax and other vegetable oil wax which operates by a self contained battery inside. The said LED light source is controlled with a switch to turn on and off of the light sequence from a low level solid light source to a sequence of flickering light action. The said LED light source has a cap with a shape of a fire flame and molded with the same biodegradable material used in the candle lamp.

A number of situations are common where it is not allowed to use candles with real flame due to fire codes but still required to have a low level light with a same form fit factor as a real candle. These situations are characterized by a requirement that the candle lamp made with candle wax, be attractive, portable, situated in areas that do not provide access to a power yet resembles a real candle ambiance.

For example, in a dimly lighted nightclub where a softly lighted decorative candle lamp would not interfere or deteriorate the intimate atmosphere or disturb other patrons in the vicinity.

Another situation is where the cities and states do not allow anymore to use a live candle with a live flame in public ball rooms where it is desired to have an attractive lighted piece that provides the required candle light atmosphere and yet give the feeling of a real candle in use.

Another situation would be a holiday occasion such as Halloween or Christmas where it is desired to have an attractive lighted piece to provide a low light.

U.S. Pat. No. 4,601,120 to Levin discloses an illuminated display (sign) formed on a flexible substrate such as a garment or umbrella having a pliable flame. This invention is not adaptable to the requirement to offer a low light source when desired with LED (Light Emitting Diodes) This invention does not provide versatility, economy or the fire code compliance that is contemplated for the present invention.

U.S. Pat. No. 4,308,572 to Davidson; Sidney (5158 Collette Ave., Encino, Calif. 91316); Davidson; Janice (5158 Collette Ave., Encino, Calif. 91316) relates to articles with light-emitting elements, such as light-emitting diodes, associated therewith, and which are energizable in sequences to provide desired visual displays. Therefore, this invention is not adaptable to the requirement to offer a low light source when desired with LED (Light Emitting Diodes) in lieu of a real candle. This invention does not provide versatility, economy or the fire code compliance that is contemplated for the present invention.

U.S. Pat. No. 6,880,958 Swarovski; Helmut, is an electric lighting device in the form of a candle, in particular a Christmas tree candle which has one light source and a mechanical holding device for detachable attachment to a support, in particular a tree branch. This patent targets an application strictly usage on a Christmas tree branch where it offers external wiring harness and offers mechanical holding device comprises a spring-loaded clamp. Therefore, this invention is not adaptable to the requirement to offer a low light source when desired with LED (Light Emitting Diodes) in lieu of a real candle. This invention does not provide versatility, economy, environmental acceptance of disposability or the fire code compliance that is contemplated for the present invention.

U.S. Pat. No. 6,595,676 Starry; P. Douglas (17160 Ransom St., Holland, Mich. 49424-1004) is method and apparatus are provided for simulating an open flame in a hand-held device, manufactured from an injection molded polymeric material such as crystal styrene and suggested may be manufactured with glass, but is not preferred because of the cost, weight, and safety considerations. This invention is not adaptable to the requirement to offer a low light source when desired with LED (Light Emitting Diodes) in lieu of a real candle, and is not made with a real candle material and does not have the form fit factor, aroma scent and a shape of a real candle, and is not naturally disposable. This invention does not provide versatility, economy, environmental acceptance of disposability or the fire code compliance that is contemplated for the present invention.

### BRIEF DESCRIPTION OF THE DRAWING

FIG. 1 is an assembly view of the lamp

FIG. 2 is the surface view of FIG. 1

FIG. 3 is a cross cut view of the candle light

FIG. 4 is a top view of the FIG. 1

FIG. 5 is a bottom view of the FIG. 1

### DESCRIPTION OF BEST MODE

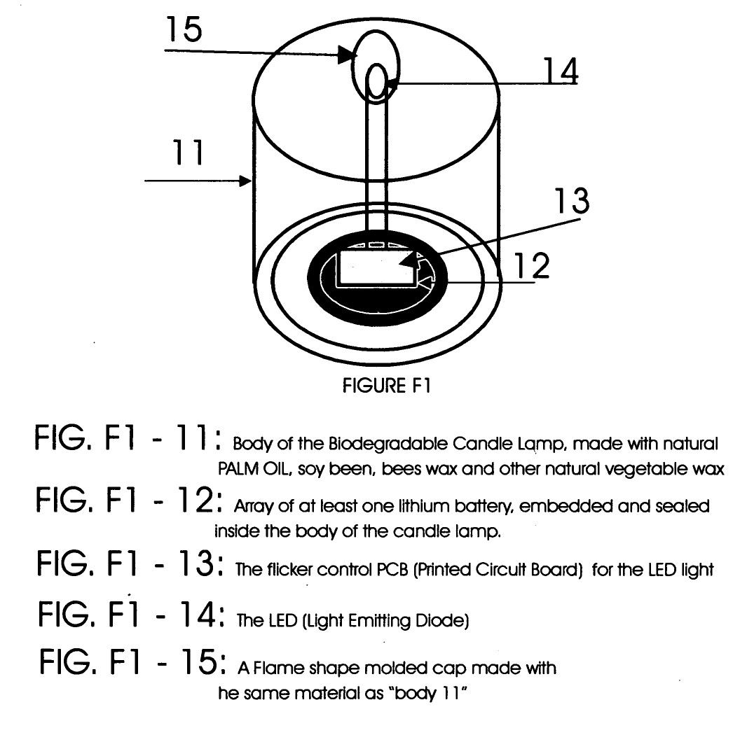

FIG. 1 is an assembly perspective view of the candle lamp of this invention. The body 11 is made with biodegradable palm oil wax, soy wax, bees wax and other vegetable wax. Wherein said LED 14 is mounted on said PCB (printed Circuit Board) 13 obtaining power from said battery 12.

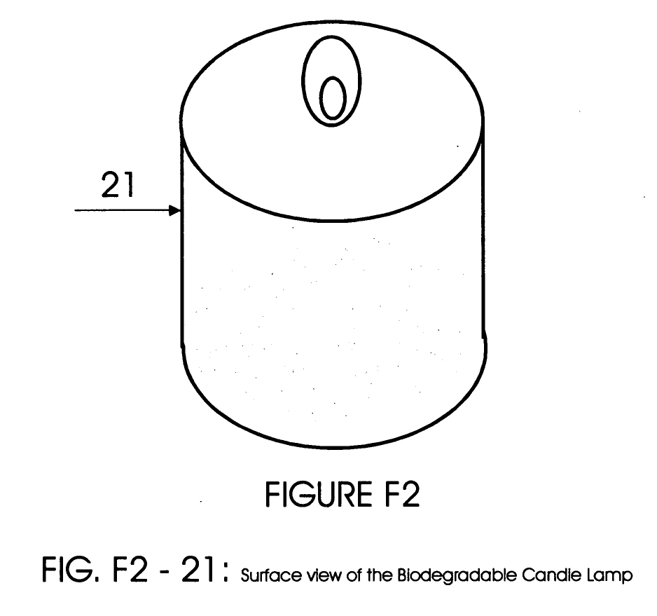

FIG. 2. is just the outside surface, a solid color scented and textured view of the FIG. 1 as shown 21.

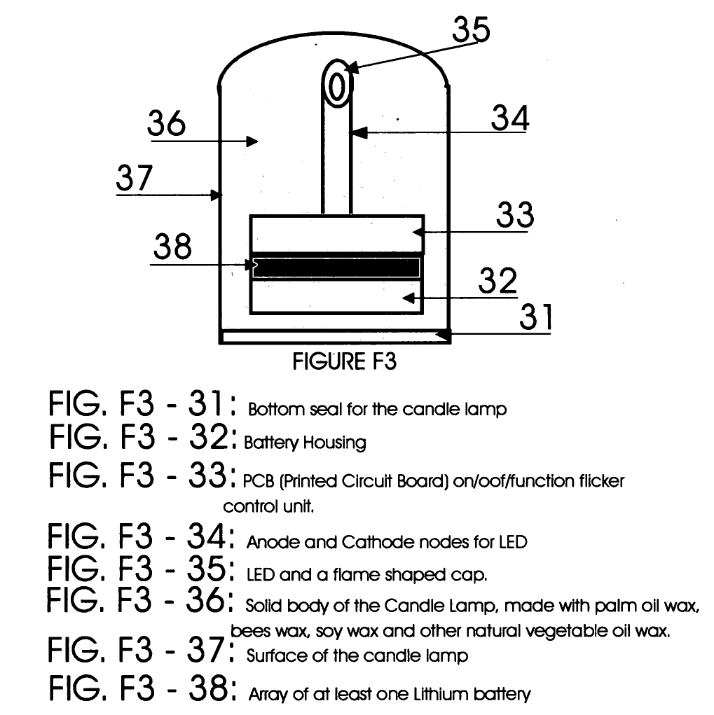

FIG. 3 shows a cross cut view of the candle lamp where the floor of the candle seal 31, the body 36, the surface 37 are made with natural biodegradable candle wax, made with the same candle wax, palm wax, translucent wax material, soy wax or other vegetable wax. The cross cut of the candle lamp illustrates the bottom seal 31, the embedded battery 32, the PCB 33 which houses the flicker control chip and the LED light 35 where the LED 35 is covered with a mold having the shape of a fire flame.

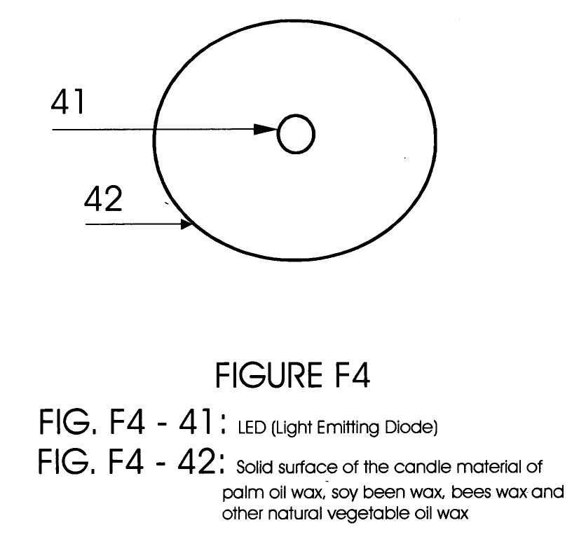

FIG. 4 shows a top view of the candle lamp where the LED (Light Emitting Diode) is used as a light source where it is sealed with a molded shape having a form of fire flame made with palm oil, soy or other vegetable wax.

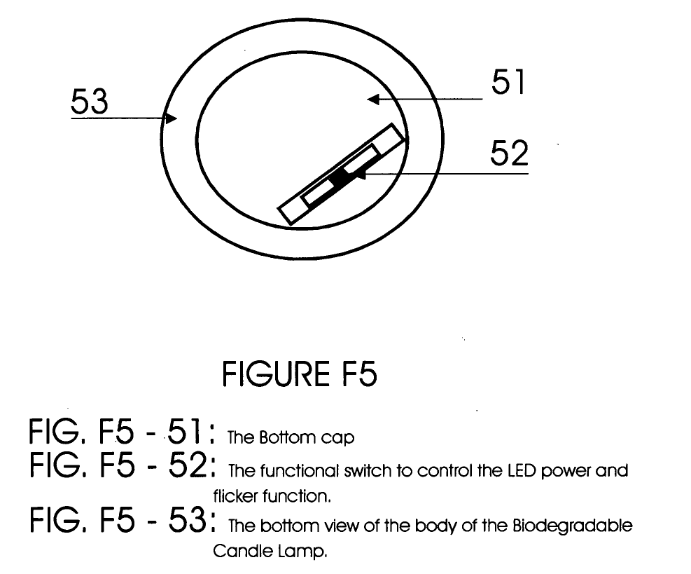

FIG. 5 is the bottom view of the candle lamp body 53, the seal 51 made with palm wax, translucent wax, soy wax or other vegetable wax with a view of a 3 way functional switch 52 offering features for battery power on/off, flickering function on or no flickering function on.

The portable, battery operated and disposable candle lamp of this invention has numerous market outlets to deliver a solution to the “No Live Fire” no “Live Flame” laws, regulations and amendments imposed by cities, fire departments and building codes.

Decorating a night club, restaurant, a wedding party, or decorating an event of any form in any city or saloon in any place whether on the ground, on the air or on the sea.

Variations and modifications of this invention may be contemplated after studying the drawing and reading the specification that are within the scope of this invention. In view of these and other embodiments, I therefore wish to define the scope of my invention by the appended claims.

What is claimed is:

1. A disposable candle lamp which comprises a shape of a candle having an aroma scent with an LED (Light Emitting Diode) mounted on top, a molded flame shape cap sometimes mounted over the LED, operates by an embedded battery inside. The LED light source is controlled with a switch at the bottom surface to turn on and off of the light sequence from a low level solid light source to a sequence of flickering light action.

2. The candle lamp of claim 1, wherein said candle is made with a real candle material such as candle wax, translucent wax, palm oil wax, soy wax, beeswax or a vegetable oil wax.

3. The candle lamp of claim 1, wherein said candle lamp has an array of at least one LED (Light Emitting Diode).

4. The candle lamp of claim 1, wherein said candle lamp has a an array of at least one molded fire flame over the said claim 3 made with the same candle wax material said in claim 2.

5. The candle lamp of claim 1, wherein said candle lamp has an embedded battery inside as a low power source.

6. The candle lamp of claim 1, wherein said candle lamp has a switch on the bottom surface to control the operation of the candle lamp.

7. The candle lamp of claim 1, wherein said candle lamp has a microchip inside to control the flicker function and speed of the candle lamp.

8. The candle lamp of claim 1, wherein said candle lamp has a smooth or textured candle surface.

9. The candle lamp of claim 1, wherein said candle lamp is made with a translucent or a solid candle material of any color.

10. The candle lamp of claim 1, wherein said candle lamp is made without and with aroma scent.

11. The candle lamp of claim 1, wherein said candle lamp is a stand alone device sits on its sealed bottom surface on any flat surface or in any container whether transparent, not transparent or translucent.

12. The candle lamp of claim 1, wherein said in claim 11 the said container can be a glass, plastic, acrylic, metal, a natural stone or another candle material.
